(19) United States
(12) Patent Application Publication
(10) Pub. No.: US 2006/0040147 A1
(43) Pub. Date: Feb. 23, 2006

(54) Liquid circulation type fuel cell

(75) Inventor: Atsushi Yamaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/204,121

(22) Filed: Aug. 16, 2005

(30) Foreign Application Priority Data
Aug. 19, 2004 (JP) 2004-239235

(51) Int. Cl. H01M 8/00

(52) U.S. Cl. 429/12; 429/13; 429/17

(57) ABSTRACT

A fuel cell generates electric power by circulating diluted fuel in a fuel cell. In a circulation dilution fuel cell system, a path is provided for leading vapor generated at an air pole of a fuel cell to a dilution fuel tank which circulates the diluted fuel of a fuel cell. Or, a fuel supply tank is provided in the upper position of the dilution fuel tank, so that the liquid fuel can be supplied to the dilution fuel tank by means of gravity. Thus, a pump for supplying the liquid fuel can be eliminated, and power consumption for controlling the fuel cell can be reduced.

### CROSS-REFERENCE TO RELATED APPLICATIONS

This application is based upon and claims the benefit of priority from the prior Japanese Patent Application No. 2004-239235, filed on Aug. 19, 2004, the entire contents of which are incorporated herein by reference.

### BACKGROUND OF THE INVENTION

1. Field of the Invention

The present invention relates to a liquid circulation type fuel cell which generates electrical power through the reaction of liquid fuel and gas, and more particularly a liquid circulation type fuel cell suitable for use as power source for an electronic apparatus.

2. Description of the Related Art

With the development of electronic apparatuses in recent years, there have been an increased number of apparatuses operated by batteries, including portable electronic devices. Among such batteries, a fuel cell, particularly a liquid circulation fuel cell, attracts attention.

Using a substance capable of permeating protons or electrons (such as a polymer electrolyte membrane), the liquid circulation fuel cell has a structure of having liquid fuel (such as aqueous solution of methanol) including the hydrogen component disposed on one side (fuel pole side), and a substance (such as air) including the oxygen component disposed on the other side (air pole side). The substance (such as a polymer electrolyte membrane) through which protons or electrons are permeable can permeate hydrogen protons in the liquid fuel, and makes the hydrogen protons combined with oxygen in the substance (such as air) including oxygen. At this time, the remainder of electrons among the hydrogen in the liquid fuel can be extracted as electricity, which functions as battery.

FIGS. 10 and 11 show explanation diagrams of the prior art. As shown in FIG. 10, a fuel cell 200 has an air pole 202 and a fuel pole 204, with an electrolyte membrane 206 sandwiched therebetween. Air is supplied from an air blower 210 to the air pole 202, while liquid fuel is supplied to the fuel pole 204.

When methanol is used as the liquid fuel, through the reaction between the hydrogen and the oxygen, water (vapor) is generated on the air pole 202 side. Also, on the fuel pole 204 side, methanol is resolved and carbon dioxide is generated. For example, in this fuel cell, assuming ideal chemical change and electric power generation are performed by making 1 mol of methanol and 1 mol of water consumed on the fuel pole 204 side, and also 1 mol of oxygen consumed on the air pole 202 side, approximately 3 mol of water is generated on the air pole 202 side, and also approximately 1 mol of carbon dioxide is generated on the fuel pole 204 side, after the power generation.

The vapor at the air pole 202 is led to a recovery tank 240, and collected as water. Further, in this fuel cell, an amount of methanol per unit area of the electrolyte membrane can be increased by the use of highly concentrated fuel. With this, an improved electromotive force can be expected, as well as a size reduction of a fuel tank. However, in the polymer electrolyte membrane 206 constituting the fuel cell, when using the highly concentrated methanol, a counter-electromotive force tends to be produced. Also from the viewpoint of lifetime, generally, it is most appropriate to supply the fuel of 1 mol concentration to the fuel cell.

For this reason, such a highly concentrated fuel is supplied from a liquid fuel tank 230 to a dilution fuel tank 220 by use of a fuel supply pump 234. The fuel is diluted with water in dilution fuel tank 220, and the diluted fuel is supplied to the fuel pole 204 by means of a fuel circulation pump 226. This water for dilution is obtained by returning the water from a recovery tank 240 to the dilution fuel tank 220 via a water supply pump 242.

Meanwhile, carbon dioxide (CO₂) generated at the fuel pole 204 is collected to the dilution fuel tank 220, together with the diluted fuel having not been consumed at the fuel pole 204. An exemplary process of the fuel cell cycle is disclosed in the Japanese Laid-open Patent Publication No. 2003-297401. As shown in FIG. 11, the liquid level in the dilution fuel tank 220 is measured using a liquid level sensor 224. If the liquid level is lower than a reference level, then a water supply pump 242 and a fuel supply pump 234 are operated to supply the fuel to the liquid fuel tank 230 and supply the water to the dilution fuel tank 220. Further, depending on the condition of a concentration sensor 222 in the dilution fuel tank 220, the fuel supply pump 234 and the water supply pump 242 are controlled.

Now, in such a fuel dilution system, as mentioned above, an amount of vapor generated at the air pole 202 is large, as compared with the amount of water supplied to the fuel pole 204. Therefore, as a result of natural cooling, a substantially large amount of water is retained in the water recovery tank 240. In order to prevent the occurrence of overflow at the water recovery tank 240, it is necessary to make the water recovery tank 240 larger in size, or operate the water supply pump 242 frequently, and supply the water into the dilution fuel tank 220.

Thus, a large number of sensors and pumps must be operated to supply the liquid fuel and the water, which causes loss of the most electric power generated for the operation of these pumps, etc. On the contrary, admitting water overflow is not preferable when considering a fuel cell application to an electronic apparatus. To make the water recovery tank 240 larger in size is problematic when applying the fuel cell to a small-sized apparatus.

### SUMMARY OF THE INVENTION

Accordingly, it is an object of the present invention to provide a liquid circulation type fuel cell with reduced power consumption for diluting the fuel, and with improved efficiency of the fuel cell.

It is another object of the present invention to provide a liquid circulation type fuel cell with reduced power consumption for supplying water to a dilution fuel tank.

It is still another object of the present invention to provide a liquid circulation type fuel cell with reduced power consumption for supplying liquid fuel to a dilution fuel tank.

Further, it is still another object of the present invention to provide a liquid circulation type fuel cell with a reduced number of pumps for supplying liquid fuel to a dilution fuel tank, and with reduced power consumption for supplying the liquid fuel.

In order to attain the aforementioned objects, in one aspect of the present invention, a liquid circulation type fuel cell includes: a fuel cell generating electric power using liquid fuel; a dilution fuel tank retaining diluted fuel in which liquid fuel is mixed with water; a circulation path of the diluted fuel circulating the diluted fuel to the fuel cell, at least having a circulation pump; a water supply path leading vapor generated at an air pole of the fuel cell to the dilution fuel tank, and supplying water to the dilution fuel tank; and a fuel supply tank supplying the liquid fuel to the dilution fuel tank.

According to the present invention, preferably, the water supply path includes a distribution supply path exhausting a portion of the vapor generated at the air pole of the fuel cell, and supplying the remainder of the vapor to the dilution fuel tank.

According to the present invention, preferably, a controller is provided for controlling to drive the water supply pump according to a detected liquid level and a fuel concentration obtained from a liquid level sensor for the fuel and a densitometer for the fuel, respectively provided in the dilution fuel tank.

According to the present invention, preferably, a water supply tank and a water supply pump for supplying water to the dilution fuel tank are provided, and the controller controls to drive a pump for supplying the liquid fuel from the fuel supply tank to the dilution fuel tank according to a detected liquid level and a fuel concentration obtained from a liquid level sensor for the fuel and a densitometer for the fuel, respectively, provided in the dilution fuel tank.

Further, in another aspect of the present invention, a liquid circulation type fuel cell includes: a fuel cell generating electric power using liquid fuel; a dilution fuel tank retaining diluted fuel in which liquid fuel is mixed with water; a circulation path of the diluted fuel circulating the diluted fuel to the fuel cell, at least having a circulation pump; and a fuel supply tank disposed in the upper position of the dilution fuel tank, supplying at least the liquid fuel from a nozzle to the dilution fuel tank by means of gravity.

According to the present invention, preferably, a water supply tank and a water supply pump are provided for supplying water to the dilution fuel tank.

According to the present invention, preferably, a water supply path is provided for leading the vapor generated at an air pole of the fuel cell to the dilution fuel tank, and for collecting water to the dilution fuel tank.

According to the present invention, preferably, a water supply path is provided for leading the vapor generated at an air pole of the fuel cell to the dilution fuel tank and for supplying water to the dilution fuel tank.

According to the present invention, preferably, the water supply path includes a distribution supply path exhausting a portion of the vapor generated at the air pole of the fuel cell, and supplying the remainder of the vapor to the dilution fuel tank.

According to the present invention, preferably, a controller is provided for controlling to drive the water supply pump according to a detected liquid level and a fuel concentration obtained from a liquid level sensor for the fuel and a densitometer for the fuel, respectively provided in the dilution fuel tank.

According to the present invention, preferably, a controller is provided for detecting concentration of the fuel in the dilution fuel tank, and depending on the detected result, detecting exhaustion of the fuel in the fuel supply tank.

According to the present invention, preferably, supply of the liquid fuel by means of gravity is adjusted by the pressure in the fuel supply tank and the surface tension of the liquid surface of the dilution fuel tank.

According to the present invention, preferably, the liquid fuel retained in the fuel supply tank has higher concentration than the diluted fuel.

According to the present invention, preferably, a valve is provided between the fuel supply tank and the dilution fuel tank for controlling supply of the liquid fuel by means of gravity.

According to the present invention, preferably, the fuel cell includes: an electrolyte membrane; a fuel pole supplying the diluted fuel on one side of the electrolyte membrane; and an oxygen pole supplying an oxidizing agent including oxygen on the other side of the electrolyte membrane.

According to the present invention, preferably, the electrolyte membrane includes a permeable membrane formed of a substance capable of permeating protons or electrons.

Further scopes and features of the present invention will become more apparent by the following description of the embodiments with the accompanied drawings.

### BRIEF DESCRIPTION OF THE DRAWINGS

FIG. 1 shows a configuration diagram of a liquid circulation fuel cell according to a first embodiment of the present invention.

FIG. 2 shows a configuration diagram of the liquid fuel cell shown in FIG. 1.

FIG. 3 shows a configuration diagram of an electronic apparatus to which the liquid fuel cell shown in FIG. 1 is applied.

FIG. 4 shows a control process flowchart of the liquid fuel cell shown in FIG. 1.

FIG. 5 shows a configuration diagram of a liquid circulation fuel cell according to a second embodiment of the present invention.

FIG. 6 shows a control process flowchart of the liquid fuel cell shown in FIG. 5.

FIG. 7 shows a configuration diagram of a liquid circulation fuel cell according to a third embodiment of the present invention.

FIG. 8 shows a configuration diagram of a liquid circulation fuel cell according to a fourth embodiment of the present invention.

FIG. 9 shows a control process flowchart of the liquid fuel cell shown in FIG. 8.

FIG. 10 shows a configuration diagram of a conventional liquid circulation fuel cell.

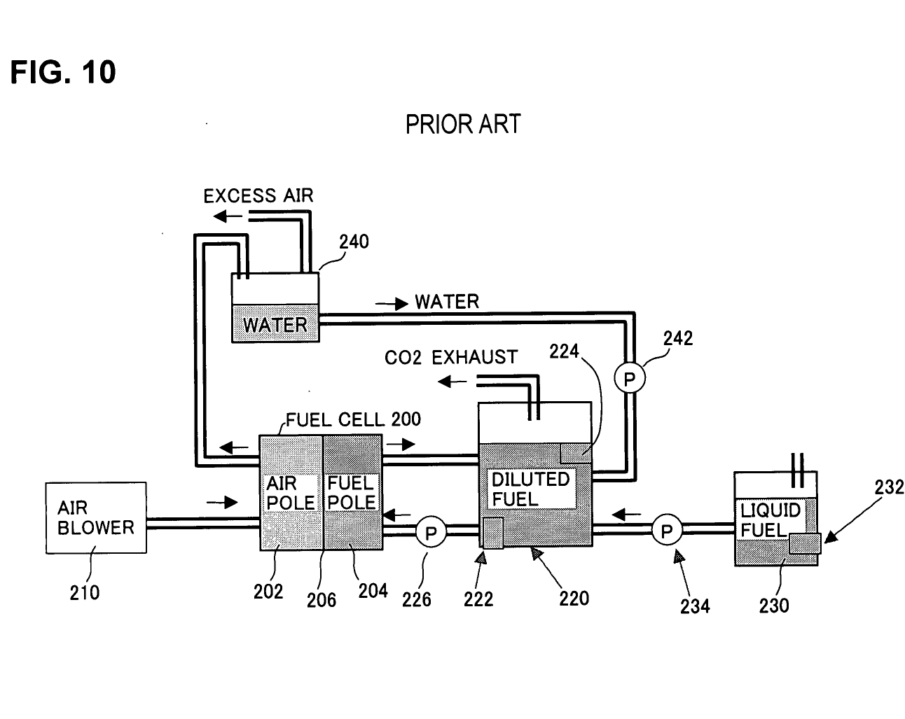

FIG. 11 shows an explanation diagram of a conventional liquid circulation fuel cell.

### DETAILED DESCRIPTION OF THE INVENTION

The preferred embodiments of the present invention are described hereinafter referring to the charts and drawings, in order of a first embodiment, a second embodiment, a third embodiment, a fourth embodiment, and other embodiments of the present invention.

### First Embodiment of the Liquid Circulation Fuel Cell

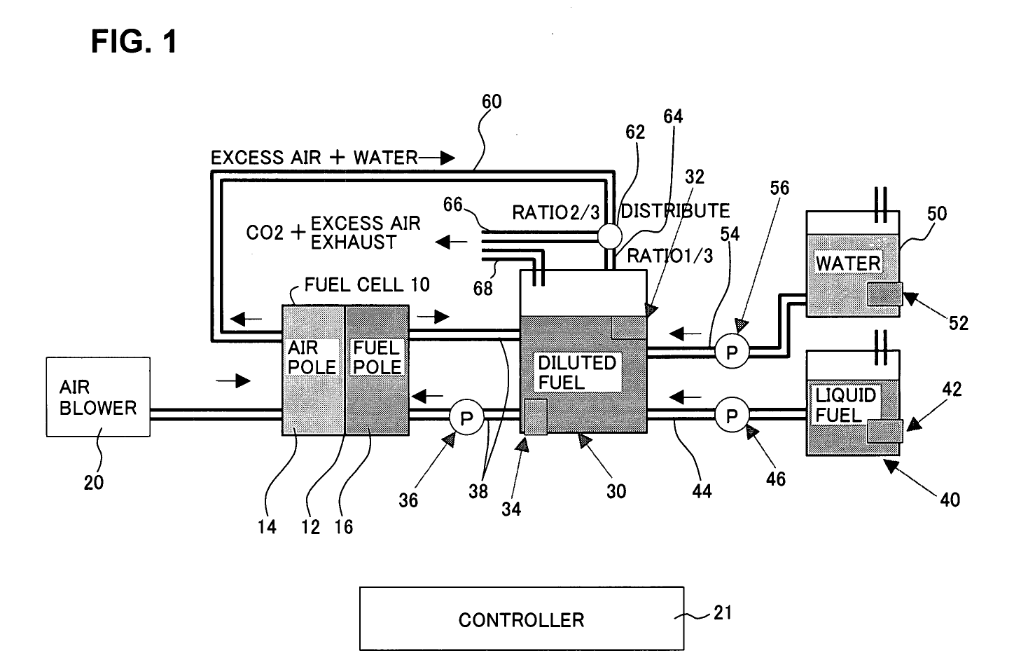

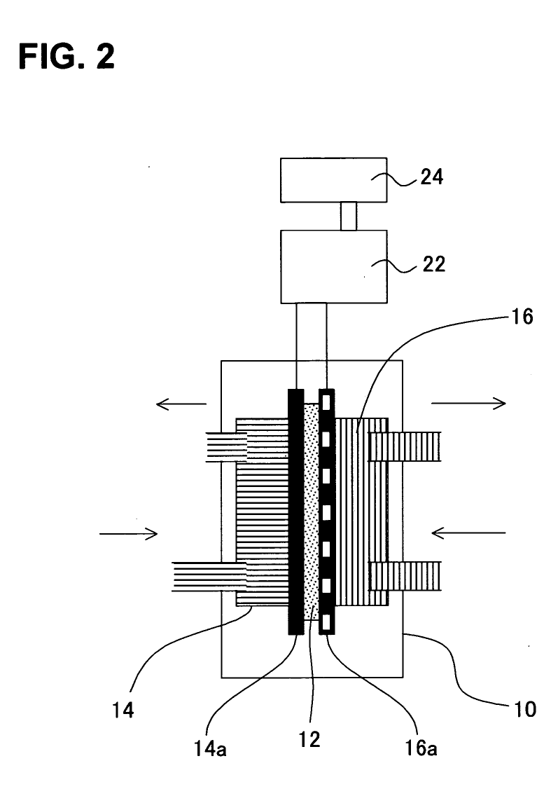

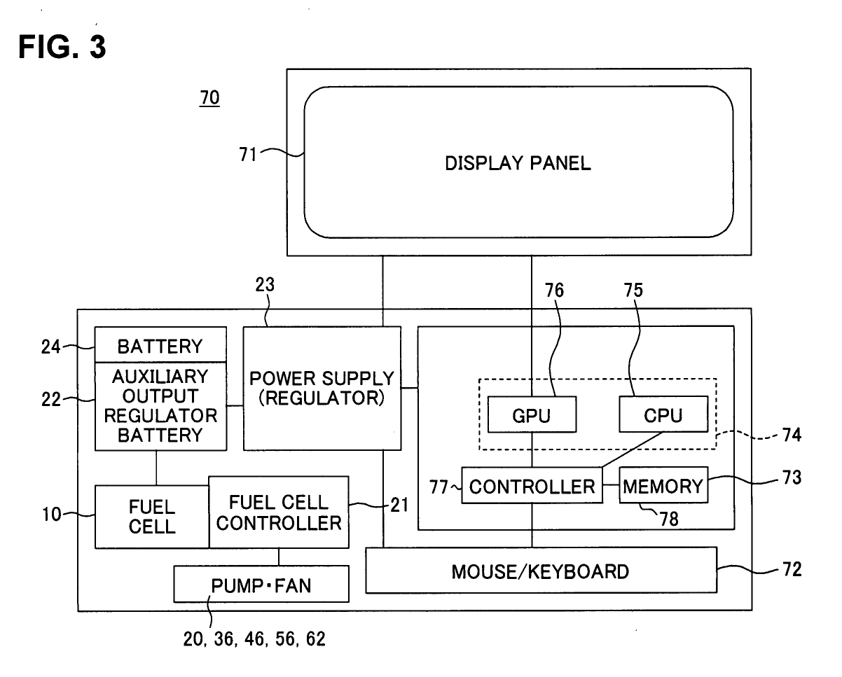

FIG. 1 shows a configuration diagram of a liquid circulation type fuel cell according to a first embodiment of the present invention. FIG. 2 shows a configuration diagram of the liquid fuel cell shown in FIG. 1. Further, FIG. 3 shows a configuration diagram of an electronic apparatus, in which the liquid fuel cell shown in FIG. 1 is applied, as one example. As shown in FIG. 1, a fuel cell 10 includes an electrolyte membrane 12, and also, an air pole 14 and a fuel pole 16 sandwiching the electrolyte membrane 12. As shown in FIG. 2, the electrolyte membrane 12 is constituted of a substance capable of permeating protons or electrons, such as a polymer electrolyte membrane, including a proton-conductive solid polymer membrane like Nafion (brand mark of DuPont Ltd.) of perfluoro sulphonic acid. On both sides of the electrolyte membrane 12, fuel electrode 16a and an oxidant electrode 14a are disposed, thereby constituting an electrolyte plate.

Air is supplied to the air pole 14 which includes oxidant electrode 14a by an air blower 20, while liquid fuel is supplied to the fuel pole 16 which includes fuel electrode 16a. An electromotive force generated between both electrodes 14a, 16a is supplied to each load via an auxiliary output regulator 22 connected to a battery 24. Or, the electromotive force charges battery 24.

When methanol is used as liquid fuel, the water (vapor) is generated on the air pole 14 side through the reaction between hydrogen and oxygen mediated by a proton catalyst of electrolyte membrane 12. Also, on the fuel pole 16 side, the methanol is resolved, and thereby carbon dioxide of bubble shape is generated. For example, in this fuel cell, when chemical change and power generation are ideally performed by making 1 mol of the methanol and 1 mol of the water consumed on the fuel pole 16 side, and also making 1 mol of oxygen consumed on the air pole 14 side, after the power generation, approximately 3 mol of the water is generated on the air pole 14 side, while approximately 1 mol of the carbon dioxide is generated on the fuel pole 16 side.

Further, using a highly concentrated fuel, an amount of methanol per unit area of the electrolyte membrane 12 can be increased. With this, an improved electromotive force can be expected, as well as a reduced size of the fuel tank. However, in the polymer electrolyte membrane 12 constituting the fuel cell, if the methanol is highly concentrated, a counter-electromotive force tends to be produced. Also from the viewpoint of lifetime, generally, it is most appropriate to supply the fuel of 1 mol concentration to the fuel cell.

For this reason, such a highly concentrated fuel is supplied from a liquid fuel tank 40 to a dilution fuel tank 30, by use of a fuel supply pump 46 through a fuel supply path 44. The fuel is diluted with water in the dilution fuel tank 30, and the diluted fuel is supplied to the fuel pole 16 by means of a fuel circulation pump 36.

This water for dilution is obtained by returning the vapor from the air pole 14 to the dilution fuel tank 30. However, as described earlier, because an amount of vapor (water) is large, the vapor fed from the air pole 14 via a path 60 is distributed in a distributor 62, and a portion of the vapor is exhausted at an air exhaust path 66, while the remainder portion is returned to the dilution fuel tank 30 via an air inflow path 64.

Namely, by utilizing the fact that the temperature in the dilution fuel tank 30 is lower than the fuel cell 10, the vapor of air pole 14 is liquefied in the dilution fuel tank 30. Further, the air including the vapor generated at the air pole 14 is distributed in distributor 62, and by using a portion of the distributed air for water recovery, a necessary amount of water can be collected. Because of a gas state, the air including vapor which is not used for water recovery does not influence the electronic apparatus, even if exhausted.

Meanwhile, the carbon dioxide (CO₂) generated at the fuel pole 16 is collected to the dilution fuel tank 30 via a circulation path 38, together with the diluted fuel having not been consumed at the fuel pole 16.

Further, in the early stage after power generation is started, the vapor generated in the fuel cell 10 cannot reach the dilution fuel tank 30, and instead, the vapor remains within a path 60. This may causes the fuel in the dilution fuel tank 30 more concentrated. To cope with this problem, a water supply tank 50 and a water supply pump 56 are provided, by which dilution water is supplied to the dilution fuel tank 30 via a water supply path 54.

The above supply of the dilution water to the dilution fuel tank 30 is temporarily performed at the start of power generation. When the vapor amount generated by the fuel cell 10 reaches the dilution fuel tank 30, the operation is suspended. Accordingly, the operation of the water supply pump 56 is limited to the minimum. With this consideration also, power consumption can be reduced.

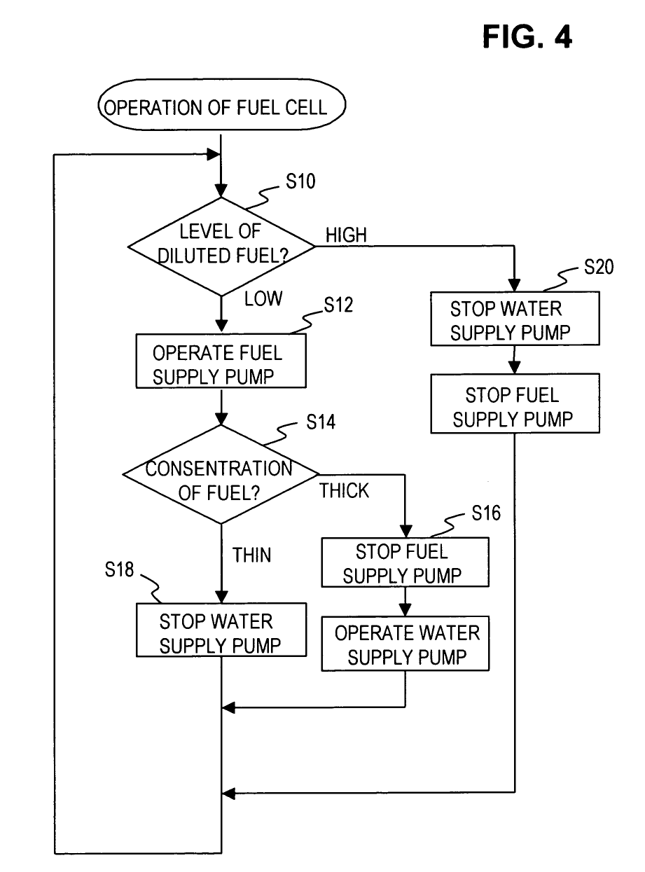

In addition, liquid level sensors 52, 42 and 32 are provided in the water supply pump 50, the fuel supply tank 40 and the dilution fuel tank 30, respectively. Further, in the dilution fuel tank 30, a fuel densitometer 34 is provided. Controller 21 monitors the measured output of each liquid level sensor 52, 42, 32 and fuel densitometer 34, and controls the operation of the water supply pump 56, the fuel supply pump 46 and the fuel circulation pump 36, depending on fuel cell operation processing described later in FIG. 4.

FIG. 3 shows an example of an apparatus to which the liquid fuel cell shown in FIG. 1 is applied. In this example, the liquid fuel cell is applied to a personal computer (mobile personal computer). A personal computer (PC) 70 includes display panel 71, circuit board 73 and mouse/keyboard 72. The circuit board 73 is provided with various kinds of memories 78, controller 77, and motherboard 74 having CPU 75 and GPU (graphic processor unit) 76 mounted thereon.

Further, PC 70 includes the aforementioned fuel cell 10, the fuel cell controller 21, various kinds of the pumps and the fan 20, 36, 66, 68, 101-105, the auxiliary output regulator 22, the battery 24, and the power supply (regulator) 23. The power is supplied from the power supply 23 to the mouse/keyboard 72, the circuit board 73 and the display panel 71.

FIG. 4 shows an operation process flowchart of the liquid fuel cell executed by the aforementioned controller 21.

(S10) The controller 21 measures the liquid level of the dilution fuel tank 30 using the liquid level sensor 32, and decides whether the liquid level is higher, or lower, than a reference level. When the liquid level is higher than the reference level, it is neither necessary to supply the fuel nor the water, and the process proceeds to step S20.

(S12) On the other hand, when the controller 21 decides the liquid level of the dilution fuel tank 30 is lower than the reference level, since the water is supposed to be supplied from the air pole 14 to the dilution fuel tank 30, first the controller 21 operates fuel the supply pump 46 to supply the liquid fuel from the liquid fuel tank 40 to the dilution fuel tank 30.

(S14) Next, the controller 21 detects the measured concentration in the dilution fuel tank 30 by the fuel concentration sensor 34, and decides whether the fuel concentration is higher, or lower, than a reference level.

(S16) When the concentration is higher than the reference level, the controller 21 halts fuel supply pump 46 so as to stop supplying the liquid fuel from the liquid fuel tank 40 to the dilution fuel tank 30. Also, the controller 21 operates the water supply pump 56 to supply water from the water supply tank 50 to the dilution fuel tank 30, so that the concentration is decreased. Then, the process returns to step S10.

(S18) Meanwhile, when the concentration is lower than the reference level, the controller 21 halts the water supply pump 56 to stop supplying the water from the water supply tank 50 to the dilution fuel tank 30, and the process returns to step S10.

(S20) In step S10, when the liquid level of the dilution fuel tank 30 is higher than the reference level, it is neither necessary to supply the fuel nor the water. Accordingly, the control 21 halts the water supply pump 56 to stop supplying the water from the water supply tank 50 to the dilution fuel tank 30. Also, the controller 21 halts the fuel supply pump 46 to stop supply the fuel from the liquid fuel tank 40 to the dilution fuel tank 30. The process then returns to step S10.

In such a way, the vapor generated in the fuel cell 10 is led into the dilution fuel tank 30 of which the temperature is lower than the fuel cell 10. Accordingly, the water supply pump 56 is operated to supply the water only when the fuel concentration in the dilution fuel tank 30 tends to become more concentrated, because of the vapor generated in the fuel cell 10 unable to reach the dilution fuel tank 30, staying in the path, in the early stage of starting the power generation.

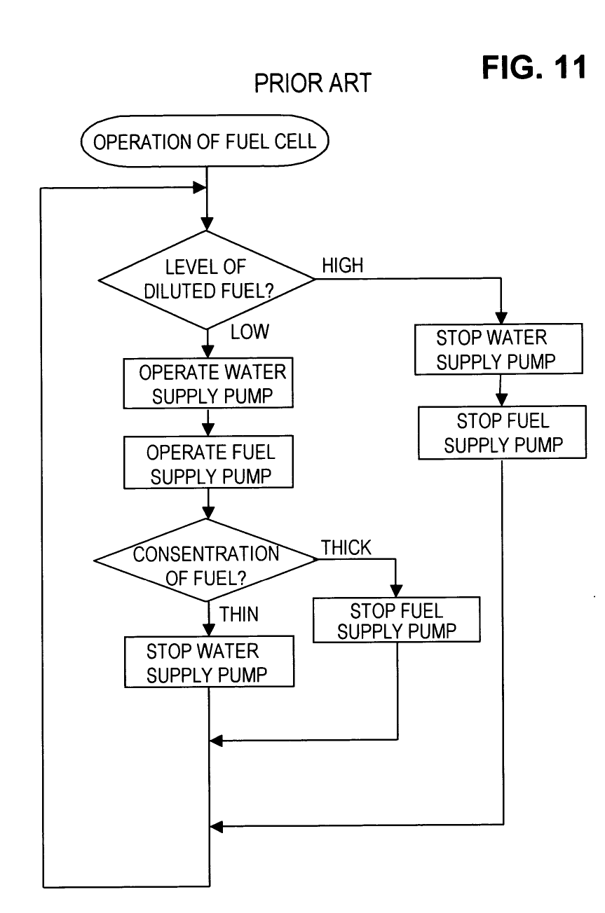

Namely, when power generation is performed continuously, the fuel cell 10 consumes 1 mol of the water and 1 mol of the fuel, and generates 3 mol of the water and 1 mol of the carbon dioxide. Therefore, by separation of carbon dioxide and extraction of water for a necessary amount, it is required to supply only the fuel. Accordingly, it is not necessary to operate the water supply pump 56 when power generation is being performed continuously. Therefore, as compared with the prior art shown in FIG. 11, the number of operation times of the water supply pump 56 can remarkably be reduced, which becomes effective in the reduction of power consumption.

Further, the air including vapor generated at the air pole 14 is distributed in the distributor 62, and by using a portion of the distributed air for water recovery, a necessary amount of water can be collected into the dilution fuel tank 30. It is also possible to prevent the fuel concentration from becoming too low, while maintaining a predetermined liquid level. Because of a gas state, the air including vapor which is not used for water recovery does not influence the electronic apparatus, even if exhausted.

### Second Embodiment of the Liquid Circulation Fuel Cell

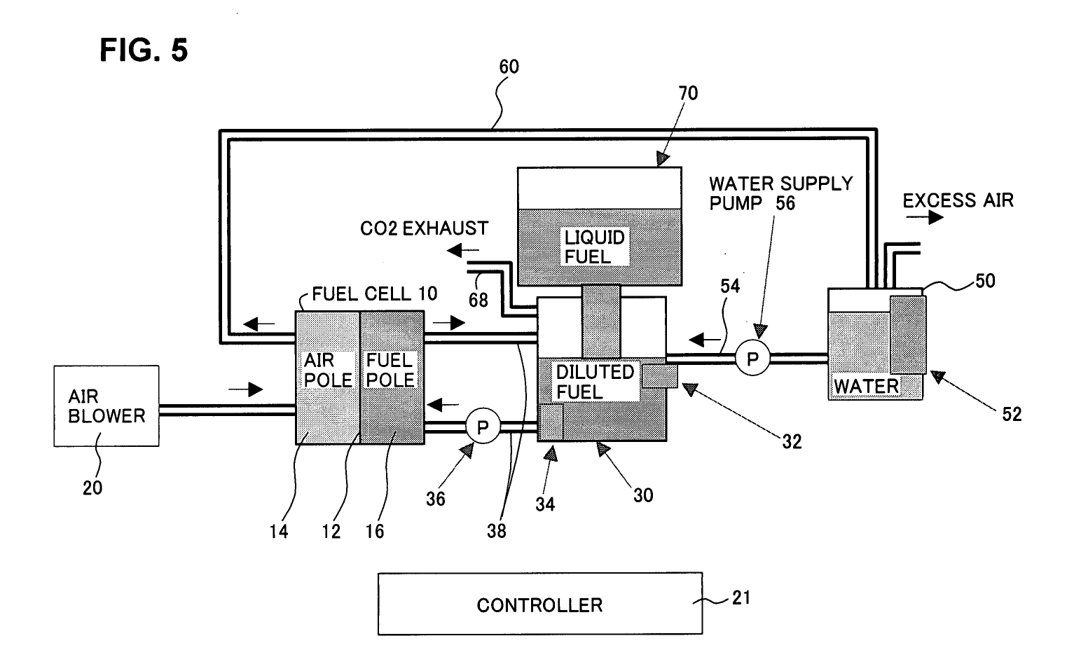

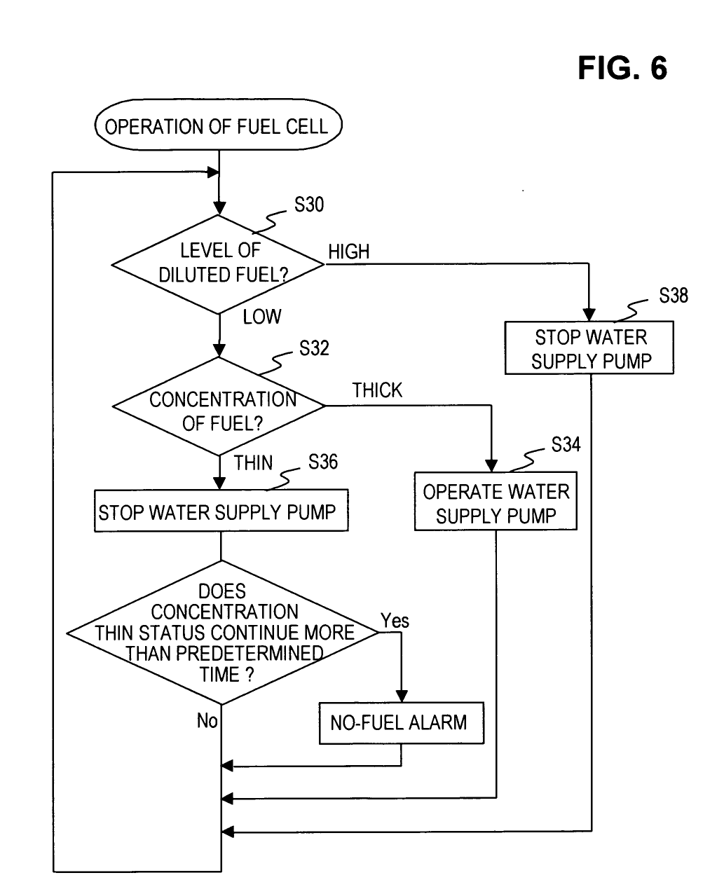

FIG. 5 shows a configuration diagram of a liquid circulation type fuel cell according to a second embodiment of the present invention. FIG. 6 shows an operation process flowchart of the fuel cell shown in FIG. 5. In this FIG. 5, like parts shown in FIGS. 1 and 3 are referred to by like numerals. Namely, as shown in FIG. 5, the fuel cell 10 includes an electrolyte membrane 12, and also, an air pole 14 and a fuel pole 16 sandwiching the electrolyte membrane 12. As shown in FIG. 2, the fuel cell 10 includes the electrolyte membrane 12. This electrolyte membrane 12 is constituted of a substance capable of permeating protons or electrons, such as a polymer electrolyte membrane, including a proton-conductive solid polymer membrane like Nafion (brand mark of DuPont) of perfluorosulphonic acid. On both sides of the electrolyte membrane 12, fuel electrode 16a and an oxidant electrode 14a are disposed, which constitutes an electrolyte plate.

Air is supplied to an air pole 14 including the above oxidant electrode 14a by the air blower 20, while the liquid fuel is supplied to a fuel pole 16 including fuel electrode 16a. An electromotive force generated between both electrodes 14a, 16a is supplied to each load via an auxiliary output regulator 22 connected to a battery 24. Or, the electromotive force charges battery 24.

When methanol is used as liquid fuel, water (vapor) is generated on the air pole 14 side through the reaction between the hydrogen and the oxygen mediated by a proton catalyst of the electrolyte membrane 12. Also, on the fuel pole 16 side, the methanol is resolved, and thereby the carbon dioxide of bubble shape is generated. For example, in this fuel cell, when chemical change and power generation are ideally performed by making 1 mol of the methanol and 1 mol of the water consumed on the fuel pole 16 side, and also making 1 mol of the oxygen consumed on the air pole 14 side, after the power generation, approximately 3 mol of the water is generated on the air pole 14 side, while approximately 1 mol of the carbon dioxide is generated on the fuel pole 16 side.

Further, using a highly concentrated fuel, an amount of methanol per unit area of the electrolyte membrane 12 can be increased. With this, an improved electromotive force can be expected, as well as a reduced size of the fuel tank. However, in the polymer electrolyte membrane 12 constituting the fuel cell, if the methanol is highly concentrated, a counter-electromotive force tends to be produced. Also from the viewpoint of lifetime, generally, it is most appropriate to supply the fuel of 1 mol concentration to the fuel cell.

For the above reason, the dilution fuel tank 30 is provided. In the dilution fuel tank 30, the fuel is diluted by the water, and the diluted fuel is supplied to the fuel pole 16 by the fuel circulation pump 36. Meanwhile, the carbon dioxide (CO₂) generated at the fuel pole 16 is collected to the dilution fuel tank 30 via a circulation path 38, together with the diluted fuel having not been consumed at the fuel pole 16.

According to this embodiment, no pump is used for supplying the fuel. Instead, a (dilution) liquid fuel tank 80 is disposed in the upper position of the dilution fuel tank 30. Based on the relation between the pressure in the liquid fuel tank 70 and the surface tension of the liquid surface in the dilution fuel tank 30, the liquid fuel is supplied to the dilution fuel tank 30. This liquid fuel tank 70 includes a nozzle in the lower position of the liquid fuel tank 70, being positioned in such a manner as contacting with the liquid level, with only the top end of the nozzle open. Further, this liquid fuel tank 70 retains the liquid fuel (for example, aqueous solution of methanol) in which the liquid fuel and the water are mixed so that the mixing ratio therebetween produces equal mol.

As described above, the liquid fuel is supplied from the liquid fuel tank 70 to the dilution fuel tank 30, based on the relation between the pressure in the liquid fuel tank 70 and the surface tension of the liquid surface in the dilution fuel tank 30. Accordingly, substantially no liquid level change is produced in the dilution fuel tank 30. Therefore, when power generation is being performed continuously, it is possible to supply fuel+water from the liquid fuel tank 70 only by means of gravity, thereby enables the system to be constituted with remarkable reduction of power loss, as compared with the conventional system.

Although the water supply system is provided, most of the system functions as protection mechanism. Namely, a water supply tank 50 and a water supply pump 56 are provided. The dilution water is supplied to the dilution fuel tank 30 through a water supply path 54. Further, the vapor from the air pole 12 is led to the water supply tank 50 through a path 60, to recover the water. Thus, the water generated at the air pole 14 can be reused.

The above supply of the dilution water to the dilution fuel tank 30 is performed only when the concentration of the fuel in the dilution fuel tank 30 becomes high for some reasons. Therefore, opportunities for operating the water supply pump 56 can be limited to the minimum. With such consideration also, the power consumption can be reduced.

In addition, the liquid level sensors 52 and 32 are provided in the water supply pump 50, and the dilution fuel tank 30, respectively. Further, in the dilution fuel tank 30, a fuel densitometer 34 is provided. Controller 21 monitors the measured output of each liquid level sensor 52 and 32 and the fuel densitometer 34. Based on the monitored results, the controller 21 controls the operation of the water supply pump 56 and the fuel circulation pump 36 according to the fuel cell operation processing, which is described below referring to FIG. 6.

FIG. 6 shows an operation process flowchart of the fuel cell executed by the aforementioned controller 21.

(S30) The controller 21 measures the liquid level of the dilution fuel tank 30 using the liquid level sensor 32, and decides whether the liquid level is higher, or lower, than a reference level. When the liquid level is higher than the reference level, it is not necessary to supply the water, and the process proceeds to step S36.

(S32) On the other hand, when the liquid level of the dilution fuel tank 30 is decided to be lower than the reference level, the controller 21 detects a measured concentration in the dilution fuel tank 30 by the fuel concentration sensor 34, and decides whether the fuel concentration is higher, or lower, than a reference level.

(S34) When the concentration is higher than the reference level, the controller 21 operates the water supply pump 56 to supply water from the water supply tank 50 to the dilution fuel tank 30, so that the concentration is decreased. Then, the process returns to step S30.

(S36) On the other hand, when the concentration is lower than the reference level, the controller 21 halts the water supply pump 56, so as to stop supplying the water from the water supply tank 50 to the dilution fuel tank 30. Subsequently, the controller 21 decides whether the state of decreased concentration lasts for a certain period. When the state of decreased concentration does not last for the certain period, the process returns to step S30. On the other hand, when the state of decreased concentration lasts for the certain period, the controller 21 decides that the fuel being empty due to the vacancy of the liquid fuel tank 80, and outputs a fuel empty alarm. Then the process returns to step S30.

(S38) In step S30, when the liquid level of the dilution fuel tank 30 is higher than the reference level, since no water supply is necessary, the controller 21 halts the water supply pump 56 to stop supplying the water from the water supply tank 50 to the dilution fuel tank 30, and the process returns to step S30.

As such, the liquid fuel is supplied from the liquid fuel tank 80 to the dilution fuel tank 30 without using a pump, based on the relation between the pressure in the liquid fuel tank 80 and the surface tension of the liquid surface in the dilution fuel tank 30. Thus, it is possible to supply fuel+water only by means of gravity when power generation is being performed continuously. This enables the system to be constituted with remarkable reduction of power loss, as compared with the conventional system. Further, the water supply system is provided for the purpose of protection. Moreover, when the concentration is decreased, it becomes possible to decide fuel empty caused by the vacancy of the liquid fuel tank 80.

### Third Embodiment of the Liquid Circulation Fuel Cell

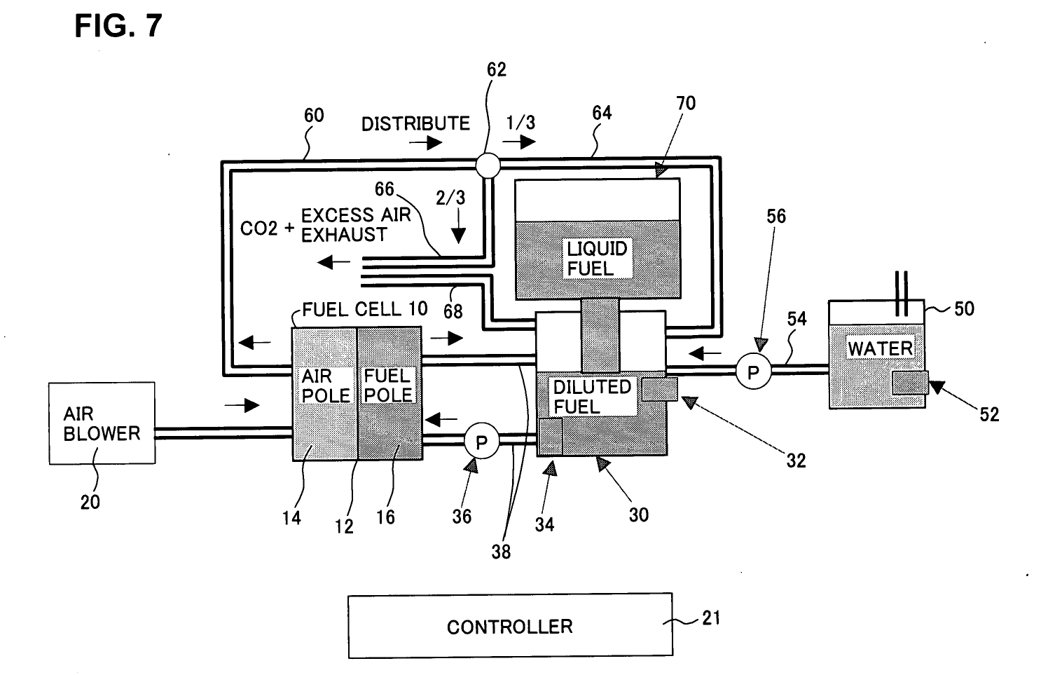

FIG. 7 shows a configuration diagram of a liquid circulation fuel type cell according to a third embodiment of the present invention. The configuration shown in FIG. 7 is obtained by combining the configuration of the first embodiment shown in FIG. 1 with the configuration of the second embodiment shown in FIG. 5. In FIG. 7, like parts shown in FIGS. 1 through 3 and FIG. 5 are referred to by like numerals.

Namely, as shown in FIG. 7, the fuel cell 10 includes an electrolyte membrane 12, and also, an air pole 14 and a fuel pole 16 sandwiching the electrolyte membrane 12. As shown in FIG. 2, the fuel cell 10 includes the electrolyte membrane 12. This electrolyte membrane 12 is constituted of a substance capable of permeating protons or electrons, such as a polymer electrolyte membrane, including a proton-conductive solid polymer membrane like Nafion (brand mark of DuPont) of perfluorosulphonic acid. On both sides of the electrolyte membrane 12, fuel electrode 16a and an oxidant electrode 14a are disposed, which constitutes an electrolyte plate.

Air is supplied to an air pole 14 including the above oxidant electrode 14a by an air blower 20, while liquid fuel is supplied to a fuel pole 16 including the fuel electrode 16a. An electromotive force generated between both electrodes 14a, 16a is supplied to each load via an auxiliary output regulator 22 connected to a battery 24. Or, the electromotive force charges battery 24.

When methanol is used as liquid fuel, water (vapor) is generated on the air pole 14 side through the reaction between the hydrogen and the oxygen mediated by a proton catalyst of the electrolyte membrane 12. Also, on the fuel pole 16 side, the methanol is resolved, and thereby the carbon dioxide of bubble shape is generated. For example, in this fuel cell, when chemical change and power generation are ideally performed by making 1 mol of the methanol and 1 mol of the water consumed on the fuel pole 16 side, and also making 1 mol of the oxygen consumed on the air pole 14 side, after the power generation, approximately 3 mol of the water is generated on the air pole 14 side, while approximately 1 mol of the carbon dioxide is generated on the fuel pole 16 side.

Further, using a highly concentrated fuel, an amount of methanol per unit area of the electrolyte membrane 12 can be increased. With this, an improved electromotive force can be expected, as well as a reduced size of the fuel tank. However, in the polymer electrolyte membrane 12 constituting the fuel cell, if the methanol is highly concentrated, a counter-electromotive force tends to be produced. Also from the viewpoint of lifetime, generally, it is most appropriate to supply the fuel of 1 mol concentration to the fuel cell.

Therefore, the fuel of high concentration is supplied from liquid fuel tank 80 to the dilution fuel tank 30 by the own weight of the fuel. The fuel is diluted by the water in the dilution fuel tank 30, and the diluted fuel is supplied to the fuel pole 16 by the fuel circulation pump 36.

This water for dilution is obtained by returning the vapor from the air pole 14 to the dilution fuel tank 30. Here, as described earlier, because an amount of vapor (water) is large, the vapor fed from the air pole 14 via a path 60 is distributed in a distributor 62, and a portion of the vapor is exhausted through an air emission path 66, while the remainder portion is returned to the dilution fuel tank 30 via an air inflow path 64.

Namely, by utilizing the fact that the temperature in the dilution fuel tank 30 is lower than the fuel cell 10, the vapor of the air pole 14 is liquefied in the dilution fuel tank 30. Further, the air including vapor generated at the air pole 14 is distributed in distributor 62, and by using a portion of the distributed air for water recovery, a necessary amount of the water can be collected. Because of a gas state, the air including vapor not used for water recovery does not influence the electronic apparatus, even if exhausted.

Meanwhile, the carbon dioxide (CO₂) generated at the fuel pole 16 is collected to the dilution fuel tank 30 via a circulation path 38, together with the diluted fuel having not been consumed at the fuel pole 16.

Further, in the early stage after power generation is started, the vapor generated in the fuel cell 10 cannot reach the dilution fuel tank 30, and instead, the vapor remains within a path 60. This may causes the fuel in the dilution fuel tank 30 more concentrated. To cope with this problem, a water supply tank 50 and a water supply pump 56 are provided, by which the dilution water is supplied to the dilution fuel tank 30 via a water supply path 54.

The above supply of the dilution water to the dilution fuel tank 30 is temporarily performed at the start of power generation. When the vapor amount generated by the fuel cell 10 reaches the dilution fuel tank 30, the operation is suspended. Accordingly, the operation of the water supply pump 56 is limited to the minimum. With this consideration also, power consumption can be reduced.

In addition, liquid level sensors 52, 32 are provided in the water supply pump 50 and the dilution fuel tank 30, respectively. Further, in the dilution fuel tank 30, a fuel densitometer 34 is provided. Controller 21 monitors the measured output of each liquid level sensor 52, 32 and the fuel densitometer 34. Based on the monitored results, the controller 21 controls the operation of the water supply pump 56 and the fuel circulation pump 36 according to the fuel cell operation processing having been described in FIG. 6.

Similar to the second embodiment of the present invention, in this third embodiment, the fuel is supplied by means of gravity without using a pump, based on the relation between the pressure in the liquid fuel tank 80 and the surface tension of the liquid surface in the dilution fuel tank 30. Moreover, in the same way as the first embodiment, a combined structure of returning the vapor generated in the fuel cell 10 to the dilution fuel tank 30 is incorporated. With this structure, it becomes possible to use liquid fuel of high concentration (even up to 100% concentration) in the liquid fuel tank 70.

Namely, with the vapor generated in the fuel cell 10 and the liquid fuel of high concentration in the liquid fuel tank 70, the amount of water and fuel equivalent to those having been consumed in the fuel cell 10 is supplemented to the dilution fuel tank 30.

In the early stage of power generation, the fuel concentration in the dilution fuel tank 30 tends to become high, and water supply becomes necessary accordingly. However, while power generation is being performed continuously, the operation of the water supply pump 56 becomes unnecessary. The liquid fuel+water can be supplied to the dilution fuel tank 30 only by means of gravity, thus a system capable of drastic reduction of power loss can be attained.

### Fourth Embodiment of the Liquid Circulation Fuel Cell

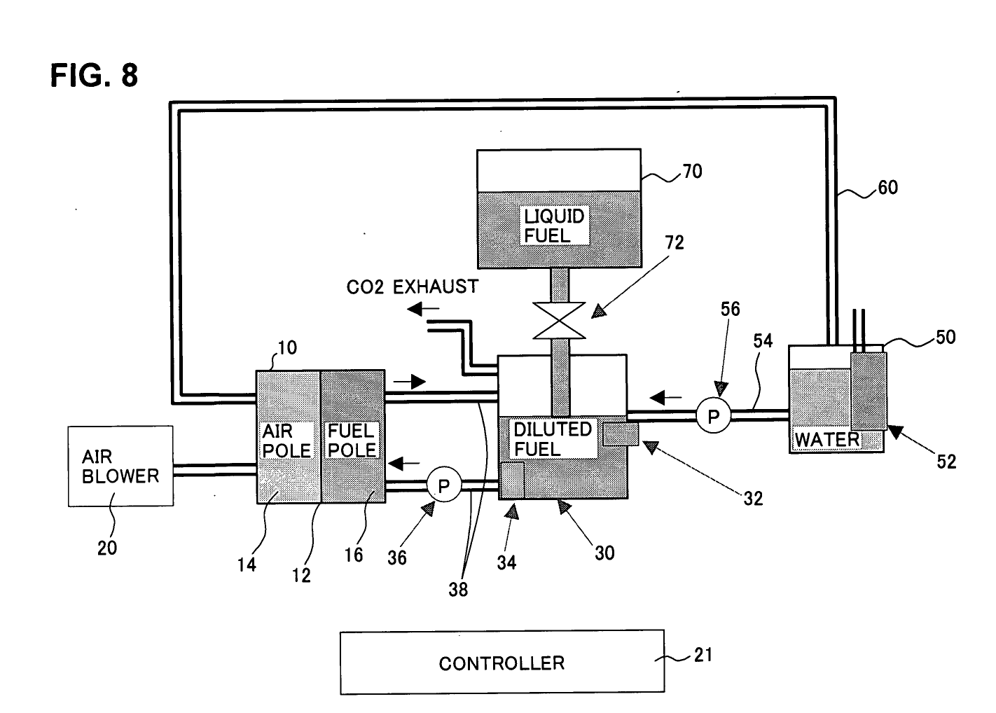

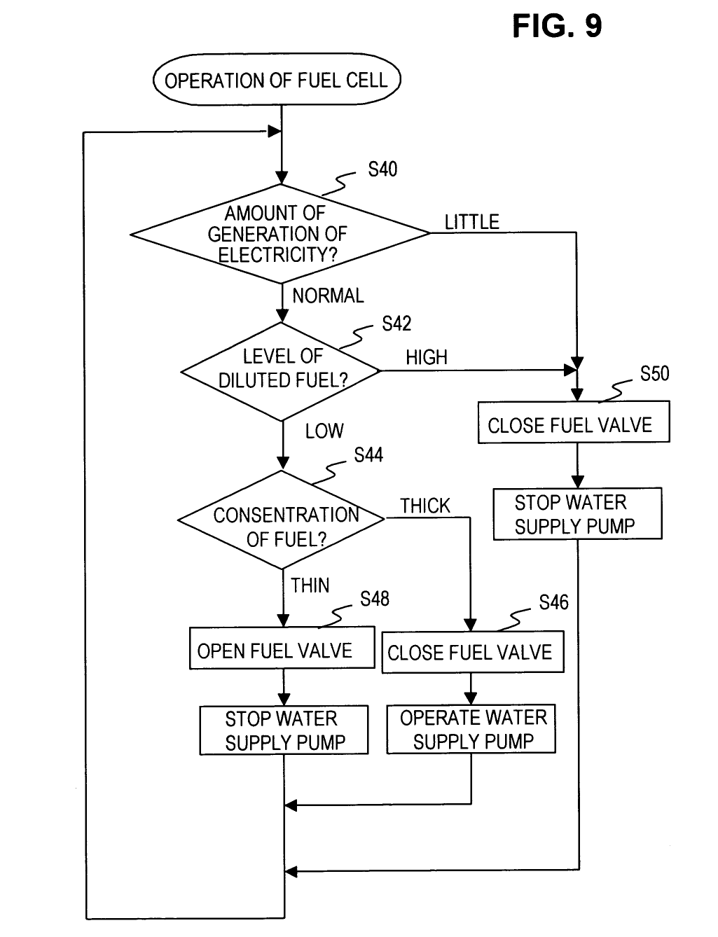

FIG. 8 shows a configuration diagram of a liquid circulation type fuel cell according to a fourth embodiment of the present invention. FIG. 9 shows an operation process flow chart of the fuel cell shown in FIG. 8. The configuration shown in FIG. 8 is an example of modification of the second embodiment shown in FIG. 5. In FIG. 8, like parts shown in FIGS. 1 through 3 and FIG. 5 are referred to by like numerals.

Namely, as shown in FIG. 8, the fuel cell 10 includes an electrolyte membrane 12, and also, an air pole 14 and a fuel pole 16 sandwiching the electrolyte membrane 12. As shown in FIG. 2, the fuel cell 10 includes the electrolyte membrane 12. This electrolyte membrane 12 is constituted of a substance capable of permeating protons or electrons, such as a polymer electrolyte membrane, including a proton-conductive solid polymer membrane like Nafion (brand mark of DuPont) of perfluorosulphonic acid. On both sides of the electrolyte membrane 12, fuel electrode 16a and an oxidant electrode 14a are disposed, which constitutes an electrolyte plate.

Air is supplied to an air pole 14 including the above oxidant electrode 14a by an air blower 20, while liquid fuel is supplied to a fuel pole 16 including fuel electrode 16a. An electromotive force generated between both electrodes 14a, 16a is supplied to each load via an auxiliary output regulator 22 connected to a battery 24. Or, the electromotive force charges battery 24.

When methanol is used as liquid fuel, water (vapor) is generated on the air pole 14 side through the reaction between the hydrogen and the oxygen mediated by a proton catalyst of electrolyte membrane 12. Also, on the fuel pole 16 side, the methanol is resolved, and thereby the carbon dioxide of bubble shape is generated. For example, in this fuel cell, when chemical change and power generation are ideally performed by making 1 mol of the methanol and 1 mol of the water consumed on the fuel pole 16 side, and also making 1 mol of the oxygen consumed on the air pole 14 side, after the power generation, approximately 3 mol of the water is generated on the air pole 14 side, while approximately 1 mol of the carbon dioxide is generated on the fuel pole 16 side.

Further, using a highly concentrated fuel, an amount of methanol per unit area of the electrolyte membrane 12 can be increased. With this, an improved electromotive force can be expected, as well as a reduced size of the fuel tank. However, in the polymer electrolyte membrane 12 constituting the fuel cell, if the methanol is highly concentrated, a counter-electromotive force tends to be produced. Also from the viewpoint of lifetime, generally, it is most appropriate to supply the fuel of 1 mol concentration to the fuel cell.

For the above reason, a dilution fuel tank 30 is provided. In the dilution fuel tank 30, fuel is diluted by the water, and the diluted fuel is supplied to the fuel pole 16 by the fuel circulation pump 36. Meanwhile, the carbon dioxide (CO₂) generated at the fuel pole 16 is collected to the dilution fuel tank 30 via a circulation path 38, together with the diluted fuel having not been consumed at the fuel pole 16.

In this embodiment also, no pump is used for supplying the fuel. Instead, a (dilution) liquid fuel tank 80 and a valve 82 are disposed, and the liquid fuel is supplied from the liquid fuel tank 80 to the dilution fuel tank 30 by means of gravity, when valve 82 is open. This liquid fuel tank 80 retains the liquid fuel (for example, aqueous solution of methanol) in which liquid fuel and water are mixed so that the mixing ratio therebetween produces equal mol.

The function of this embodiment is described hereafter. In the second embodiment shown in FIG. 5 and the third embodiment shown in FIG. 7, the fuel is supplied by means of gravity and the surface tension of the liquid. Here, when such a fuel cell is used in mobile environment, there may be cases that the liquid fuel tank 80 and the dilution fuel tank 30 are swung or tilted to a large extent.

Generally, excessive fuel supply caused by some degree of vibration or swing can be reduced by disposing the nozzle of liquid fuel tank 80 near the center of the liquid surface of dilution fuel tank 30, and further by setting the upper limit of water feed to one-half of the capacity of the dilution fuel tank 30.

However, when the fuel cell system is tilted by 90 degrees or rapidly swung up and down, the surface tension cannot be maintained in the above second or third embodiments, which may result in excessive fuel supply. To cope with this problem, according to this fourth embodiment, valve 82 is provided for avoiding an excessive fuel supply. This valve 82 is operated based on a power generation condition and the level of the liquid fuel in the dilution fuel tank 30.

Therefore, when power generation is being performed continuously, it is possible to supply fuel+water from the liquid fuel tank 80 only by means of gravity, which enables the system to be constituted with remarkable reduction of power loss, as compared with the conventional system. At the same time, a protection function for use in the mobile environment can be given.

Additionally, although a water supply system is provided, most of the system functions as protection mechanism. Namely, there are provided a water supply tank 50 and a water supply pump 56. The dilution water is supplied to the dilution fuel tank 30 through a water supply path 54. Further, the vapor from the air pole 12 is led to the water supply tank 50 through a path 60, to recover the water. Thus, the water generated at the air pole 14 can be reused.

The above supply of the dilution water to the dilution fuel tank 30 is performed only when the concentration of the fuel in the dilution fuel tank 30 becomes high for some reasons. Therefore, opportunities for operating the water supply pump 56 can be limited to the minimum. With such consideration also, the power consumption can be reduced.

Also, the liquid level sensors 52 and 32 are provided in the water supply pump 50 and the dilution fuel tank 30, respectively. Further, in the dilution fuel tank 30, a fuel densitometer 34 is provided. Controller 21 monitors the measured output of each liquid level sensor 52, 32 and the fuel densitometer 34, and also monitors the power generation condition of the fuel cell 10. Based on the monitored results, the controller 21 controls the operation of the water supply pump 56 and the fuel circulation pump 36 according to the fuel cell operation processing, which is described below referring to FIG. 9.

FIG. 9 shows an operation process flowchart of the fuel cell shown executed by the aforementioned controller 21.

(S40) The controller 21 measures a power generation amount required by the load. For example, the controller 21 detects the power (generation amount) supplied from the auxiliary output regulator 22 to the load. By comparing with a reference value, the controller 21 decides whether the required generation amount is in a normal level or smaller. When the required level is smaller, the process proceeds to step S50.

(S42) On deciding that the required power generation amount is normal, the controller 21 measures the liquid level of the dilution fuel tank 30 using the liquid level sensor 32, to decide whether the liquid level is higher, or lower, than the reference level. When the liquid level is higher than the reference level, no supply of water is necessary, and the process proceeds to step 50.

(S44) On the other hand, when the liquid level of the dilution fuel tank 30 is decided to be lower than the reference level, the controller 21 detects a measured concentration in the dilution fuel tank 30 by the fuel concentration sensor 34, and decides whether the fuel concentration is higher, or lower, than a reference level.

(S46) When the concentration is higher than the reference level, the controller 21 first shuts the fuel valve 82, and then operates the water supply pump 56 to supply water from the water supply pump 50 to the dilution fuel tank 30, so that the concentration is decreased. Then, the process returns to step S40.

(S48) On the other hand, when the concentration is lower than the reference level, the controller 21 halts the water supply pump 56 to stop supplying the water from the water supply tank 50 to the dilution fuel tank 30. The controller 21 also opens the fuel valve 82, and supplies fuel+water from the liquid fuel tank 80 to the dilution fuel tank 30 by the own weight of the fuel. Thereafter, the process proceeds to step S40.

(S50) When the required power generation amount is decided small in step S40, or the liquid level of the dilution fuel tank 30 is decided higher than the reference value in step S42, neither fuel supply nor water supply is necessary. Therefore, the controller 21 shuts the fuel valve 82, and also halts the water supply pump 56. Thus, supply of water from the water supply tank 50 and supply of fuel from the dilution fuel tank 30 are stopped, and the process returns to step S40.

In such a way, it becomes possible to avoid an excessive fuel supply even when the fuel cell is tilted in order of 90 degrees, or rapidly swung up and down, in the configuration of supplying the liquid fuel to dilution fuel tank 30 by the own weight of the fuel. Namely, by providing valve 82 for avoiding an excessive fuel supply, and by operating valve 82 according to both the required power generation amount obtained from the use amount of the power in the load and the liquid level of the fuel, excessive fuel supply can be prevented. When the required generation amount is small, for example, to the extent that the required power can be supplied by battery (secondary battery) 24 (refer to FIG. 3), there is no need of generating the power, and neither fuel nor water is supplied.

Additionally, when the fuel cell system is rapidly swung up and down, it is difficult to grasp the liquid level of the fuel properly. Therefore, for a proper detection of the liquid level of the fuel, it is preferable to use a liquid level sensor having a certain time constant to react, or having a mechanism against chattering.

### Other Embodiments

In the aforementioned fourth embodiment, it has been described using the example of modification based on the second embodiment shown in FIG. 5. However, it is also possible to configure a modification example based on the third embodiment.

Also, although methanol aqueous solution is used as liquid fuel in the foregoing embodiments, it is not limited to the methanol aqueous solution. It is also possible to use hydrocarbon such as dimethylether, diethylether and cyclohexane, or alkaline solution of sodium borohydride, sodium tetrahydroborate (NaBH₄), or the like.

Further, as oxidizing agent, either air or oxygen in the air is used in the above description. However, the oxidizing agent is not limited to the above, and instead, using hydrogen peroxide (H₂O₂) water, oxygen generated by the decomposition reaction of peroxidation may also be available.

Further, in the foregoing description, the electrolyte membrane is explained as a membrane capable of permeating protons. However, the electrolyte membrane can be configured of a membrane capable of permeating electrons. In addition, although the electronic apparatus has been explained using a personal computer, it is possible to apply the method according to the present invention to other portable electronic apparatuses, such as portable telephone, motion robot and toy.

As the effects of the present invention, in a circulation dilution-fuel cell system, the vapor from an air pole of the fuel cell is directly led to a dilution fuel tank, or the fuel is supplied by means of gravity. Thus, it becomes possible to eliminate pumps therefor, and to reduce the power consumed for controlling the fuel cell. Thus, the efficiency of the fuel cell system can be improved.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A liquid circulation type fuel cell comprising:
a fuel cell for generating electric power using liquid fuel;
a dilution fuel tank for retaining diluted fuel in which the liquid fuel is mixed with water;
a circulation path of the diluted fuel for circulating the diluted fuel to the fuel cell, at least having a circulation pump;
a water supply path for leading vapor generated at an air pole of the fuel cell to the dilution fuel tank, and supplying water to the dilution fuel tank; and
a fuel supply tank for supplying the liquid fuel to the dilution fuel tank.

2. The liquid circulation type fuel cell according to claim 1,
wherein the water supply path comprises a distribution supply path for exhausting a portion of the vapor generated at the air pole of the fuel cell, and supplying the remainder of the vapor to the dilution fuel tank.

3. The liquid circulation type fuel cell according to claim 1,
wherein further comprises a controller for controlling to drive the water supply pump according to a detected liquid level and a fuel concentration obtained from a liquid level sensor for the fuel and a densitometer for the fuel, respectively provided in the dilution fuel tank

4. The liquid circulation type fuel cell according to claim 3,
wherein further comprises a water supply tank and a water supply pump for supplying water to the dilution fuel tank are provided,
and wherein the controller controls to drive the water supply pump for supplying the liquid fuel from the fuel supply tank to the dilution fuel tank, according to a detected liquid level and a fuel concentration obtained from a liquid level sensor for the fuel and a densitometer for the fuel, respectively provided in the dilution fuel tank.

5. A liquid circulation type fuel cell comprising:
a fuel cell for generating electric power using liquid fuel;
a dilution fuel tank for retaining diluted fuel in which liquid fuel is mixed with water;
a circulation path of the diluted fuel for circulating the diluted fuel to the fuel cell, at least having a circulation pump; and
a fuel supply tank disposed in the upper position of the dilution fuel tank, supplying at least the liquid fuel from a nozzle to the dilution fuel tank by means of gravity.

6. The liquid circulation type fuel cell according to claim 5,
wherein further comprises a water supply tank and a water supply pump for supplying water to the dilution fuel tank.

7. The liquid circulation type fuel cell according to claim 6,
wherein further comprises a water supply path for leading the vapor generated at an air pole of the fuel cell to the dilution fuel tank, and for collecting water to the dilution fuel tank.

8. The liquid circulation type fuel cell according to claim 5,
wherein further comprises a water supply path for leading the vapor generated at an air pole of the fuel cell to the dilution fuel tank, and for supplying water to the dilution fuel tank.

9. The liquid circulation type fuel cell according to claim 8,
wherein the water supply path comprises a distribution supply path for exhausting a portion of the vapor generated at the air pole of the fuel cell, and supplying the remainder of the vapor to the dilution fuel tank.

10. The liquid circulation type fuel cell according to claim 6, further comprising:
a controller controlling to drive the water supply pump according to a detected liquid level and a fuel concentration obtained from a liquid level sensor for the fuel and a densitometer for the fuel, respectively provided in the dilution fuel tank.

11. The liquid circulation type fuel cell according to claim 5,
wherein further comprises a controller for detecting concentration of the fuel in the dilution fuel tank, and depending on the detected result, detecting empty of the fuel in the fuel supply tank.

12. The liquid circulation type fuel cell according to claim 5,
wherein supply of the liquid fuel by means of gravity is adjusted by the pressure in the fuel supply tank and the surface tension of the liquid surface of the dilution fuel tank.

13. The liquid circulation type fuel cell according to claim 8,
wherein the liquid fuel retained in the fuel supply tank has higher concentration than the diluted fuel.

14. The liquid circulation type fuel cell according to claim 5,
wherein further comprises a valve provided between the fuel supply tank and the dilution fuel tank, for controlling supply of the liquid fuel by means of gravity.

15. The liquid circulation type fuel cell according to claim 1,
wherein the fuel cell comprises:
an electrolyte membrane;
a fuel pole supplying the diluted fuel on one side of the electrolyte membrane; and
an oxygen pole supplying an oxidizing agent including oxygen on the other side of the electrolyte membrane.

16. The liquid circulation type fuel cell according to claim 15,
wherein the electrolyte membrane comprises a permeable membrane formed of a substance capable of permeating protons or electrons.

17. The liquid circulation type fuel cell according to claim 5,
wherein the fuel cell comprises:
an electrolyte membrane;
a fuel pole supplying the diluted fuel on one side of the electrolyte membrane; and
an oxygen pole supplying an oxidizing agent including oxygen on the other side of the electrolyte membrane.

18. The liquid circulation type fuel cell according to claim 17,
wherein the electrolyte membrane comprises a permeable membrane formed of a substance capable of permeating protons or electrons.
